(19) United States
(12) Patent Application Publication
(10) Pub. No.: US 2004/0246837 A1
(43) Pub. Date: Dec. 9, 2004

(54) Optical disk controller and method of controlling optical disk apparatus

(75) Inventors: Tatsuo Suzuki, Kyoto (JP); Tokuyuki Saijou, Osaka (JP); Tsutomu Hashimoto, Kyoto (JP); Yoshinori Taniguchi, Osaka (JP)

Correspondence Address: McDERMOTT, WILL & EMERY, 600 13th Street, N.W., Washington, DC, 20005-3096, US

(73) Assignee: Matsushita Electric Industrial Co., Ltd.

(21) Appl. No.: 10/765,835

(22) Filed: Jan. 29, 2004

(30) Foreign Application Priority Data
Jan. 29, 2003 (JP) P2003-020509

(51) Int. Cl. G11B 5/09

(52) U.S. Cl. 369/47.22; 369/47.14; 369/53.15

(57) ABSTRACT

A function of controlling a seek in an optical disk and a transmission process block for transmitting information on the storage location of data recorded on the optical disk including defect management information indicating an alternative storage location for a defective block to a μ code are provided in firmware, and a detection process block for detecting the storage location of the data recorded on the optical disk based on the storage location information and a notification process block for notifying the firmware of a request for a seek for the storage location of the data recorded in the optical disk thus detected. Therefore, in an optical disk controller for performing processes according to the CD-MRW standards, the performance of a process unique to the CD-MRW standards is improved even when a plurality of programs are executed independently of each other by a single CPU.

### BACKGROUND OF THE INVENTION

1. Field of the Invention

The present invention relates to an optical disk controller for performing processes based on the CD-MRW standards and a method of controlling an optical disk apparatus.

2. Description of the Related Art

An optical disk apparatus according to the related art is provided with two programs, i.e., firmware (F/W) that is a program for controlling the system as a whole and a program (μ code) for processing signals on an optical disk.

FIG. 10 is a block diagram showing a configuration of an optical disk apparatus utilizing an optical disk controller according to the related art. In FIG. 10, reference numeral 1 represents the optical disk apparatus; reference numeral 2 represents a pick-up control section; reference numeral 3 represents a reproduction signal generating section; reference numeral 4 represents a buffer memory control section; reference numeral 5 represents an interface control section; reference numeral 6 represents a host personal computer (host PC); reference numeral 7 represents a CPU of the optical disk controller; reference numeral 8 represents a RAM such as DRAM; reference numeral 9 represents a flash memory; and reference numeral 10 represents a mask ROM.

The firmware and the μ code have no link each other, and they are programs executed by the single CPU 7 independently. The firmware is stored in the flash memory 9 and executed by the CPU 7 at a rate in the range from 2 to 8 MIPS, for example. The μ code is stored in the mask ROM 10 and executed by the CPU 7 at a rate of 33 MIPS, for example. Thus, the μ code can operate faster than the firmware.

The CPU 7, which controls the entire system of the optical disk apparatus 1, causes the firmware and the μ code to operate on a switched basis. When a data transfer request command for reading data stored on an optical disk is received from the host PC 6 through the interface control section 5, the CPU 7 makes a seek request such that a light spot is moved to the pick-up control section 2 for controlling the light spot.

The pick-up control section 2 for controlling a light pick-up loaded with a light source such as a semiconductor laser projects a light beam on a signal recording surface of an optical disk that is driven for rotation by a driving mechanism such as a spindle motor which is not shown, and it detects light reflected from the signal recording surface of the optical disk as an electrical signal by receiving the same with a photo detector.

The pick-up control section 2 amplifies the signal detected by the light pick-up to predetermined amplitude with an amplifier. From the resultant signal, an adding circuit generates an RF signal by obtaining the total quantity of reflected light, and a differential circuit generates a servo signal indicating a focus error and a tracking error. The RF signal that is a sum signal is input to the reproduction signal generating section 3 for generating a reproduction signal through an equalizing circuit that emphasizes only the RF signal band.

The servo signal that is a difference signal is subjected to amplitude compensation and gain compensation at a servo circuit. It is thereafter subjected to current amplification and output to an actuator that is incorporated in the optical pick-up. As a result, the optical pick-up is driven in a direction perpendicular to the information surface of the optical disk (focus direction) and a direction across a spiral track on the information surface (tracking direction) and controlled such that a light beam (light spot) on the optical disk properly scans the track.

Further, the RF signal is changed into a binary form at a predetermined slice level by a binary circuit in the reproduction signal generating section 3 and synchronized with a clock in a PLL circuit. Data is extracted from the synchronized data in a predetermined detection window generated from the clock.

The extracted data is arranged on a two-dimensional or three-dimensional basis into a series of data on which error correction is performed based on a predetermined generating function. The error-corrected data is accumulated in a buffer memory by the buffer memory control section 4. The accumulated data is transferred to the host PC 6 at predetermined timing by the interface control section 5.

Referring to processes in optical disk apparatus as described above, in order to achieve the system standards of the optical disk apparatus, the firmware is a program that is designed uniquely (i.e., customized) for each of the set manufacturers in general and is stored in a flash memory to facilitate customization. By providing such firmware, optical disk apparatus having optical pick-ups and optical disk driving sections in different standards can be controlled in an optimum way in accordance with the respective specifications.

The μ code is a program for performing complicated signal processing associated with optical disks using a signal processing circuit and for allowing the firmware to utilize results of the signal processing easily. Since the μ code allows a process to be commonly performed regardless of the standards of optical disk apparatus, a cost reduction can be achieved by providing the μ code in the form of a ROM.

Since the firmware and the μ code are programs that are executed by the CPU 7 independently of each other and are not linked to each other, processes of them are linked through the RAM 8 having a small capacity that can be accessed from both of the firmware and the μ code.

Recently, CD-RW that are writable optical disks are spreading at a high rate, which has resulted in stronger demands for standardization of packet writing standards in order to make CD-RW as easy to use as floppy disks. The Mt. Rainier standards (CD-MRW standards) have been developed as such standardized specifications.

Novel processes unique to the CD-MRW standards include a defect managing process and a reproduction process that is performed across a spear area residing between the last address of each data area (DA) and the first address of the next data area (hereinafter referred to as “cross-DA process”). Such processes have been implemented on a firmware basis as shown in FIG. 10 according to the related art because they involve control of an optical pick-up to be performed uniquely according to the standards of each optical disk apparatus.

High speed reproduction is an essential technique for recent optical disk apparatus. However, high speed reproduction places a great load on a CPU and, a problem has therefore arisen in that the defect managing process and the cross-DA process unique to the CD-MRW standards (hereinafter, they are collectively referred to as “CD-MRW processes”) are incompatible with high speed reproduction from the viewpoint of processing speed when they are implemented on a firmware basis.

While a possible solution to this problem is to implement all CD-MRW processes on a μ code basis, since the CD-MRW processes involve control of an optical pick-up that is unique to the specification of each optical disk apparatus, the use of a μ code results in a need for creating a ROM that is customized for the specification of each optical disk apparatus, which increases the cost of the apparatus.

When entire firmware stored in a flash memory is executed by loading it to a RAM, it is possible to achieve a high speed while achieving customization to the specification of each optical disk apparatus on a firmware basis. However, since this necessitates a RAM having a great capacity, there will be a great increase in the cost of an optical disk controller.

### SUMMARY OF THE INVENTION

The object of the invention is to provide an optical disk controller for performing processes based on the CD-MRW standards and a method of controlling an optical disk, which make it possible to perform processes unique to the CD-MRW standards with improved performance and reproduce an optical disk at a high speed even when a plurality of programs are executed by a single CPU independently.

The invention provides an optical disk controller, which performs a control associated with record of data on an optical disk and reproduction of data recorded on the optical disk, having: a first memory for storing a first software to perform a first processing; a second memory for storing a second software to perform a second processing; and processing means for reading the first and second software from the first memory and the second memory to independently perform the first processing and the second processing each other, the first processing includes a seek control processing of performing a seek control of the optical disk, and a transmission processing of transmitting information indicating the storage location of data recorded on the optical disk, which includes defect management information indicating an alternative storage location of a defective block, to the second software, and the second processing includes a detection processing of detecting the storage location of data recorded on the optical disk based on the storage location information, and a notification processing of notifying a request for seeking the storage location, in which data detected by the detection process is recorded on the optical disk, to the first software.

According to the configuration, by providing the first processing with the transmission processing, and providing the second processing with the detection processing and the notification processing, a customized part of a defect managing process unique to the CD-MRW standards can be allotted to the first processing, a part of the same process common to any optical disk apparatus can be allotted to the second processing. This makes it possible to improve processing performance and to achiever high speed reproduction through the improvement in processing performance.

Furthermore, the optical disk controller has a plurality of the first software; and a plurality of the first memory.

Furthermore, a speed of which the processing means reads the first software from the first memory is lower than a speed of which the processing means reads the second software from the second memory.

Furthermore, the first memory is flash memory, and the second memory is ROM.

Furthermore, the first program is firmware and the second program is a μ code.

Furthermore, the second processing includes a defect detection processing of detecting that a block of the storage location detected by the detection processing is a defective block, and judgment processing of judging whether an alternative storage location of data to be read is two or more consecutive blocks based on the defect management information when the block of the storage location of detected by the detection processing is the defective block, wherein two or more consecutive blocks of data read as a result of a seek for a first block of the alternative storage location are stored in a buffer memory to accommodate a second and subsequent blocks of the alternative storage location when the judgment processing judges that the alternative storage location of the data to be read is two or more consecutive blocks.

According to the configurations, when it is detected that the storage location of data to be read is a defective block, processing performance can be improved by avoiding duplicate seek requests for two or more consecutive blocks of data stored in the alternative storage location.

Furthermore, the first processing has information extraction processing of extracting only information required for reproduction of the data stored on the optical disk and organizing the information into a defect management information to be transmitted to the second software.

According to the configuration, the defect management information transmitted to the second software can be simplified by providing the first software with the information extraction processing, which makes it possible to reduce the burden placed on the second software in searching defective blocks.

Furthermore, the defect management information is organized in tabular form.

Furthermore, data storage locations of the defect management information are arranged in an ascending order.

Furthermore, the defect management information includes an identification code which indicates an end of a table.

According to the configurations, the defect managing information is organized in tabular form in which data storage locations are arranged in an ascending order and/or there is provided an identification code indicating the end of the table, which allows the second software to perform binary tree search of defective blocks easily at a high speed.

Furthermore, the defect management information is in conformity with Mt. Rainier standards of optical disks.

The invention provides an optical disk controller, which performs a control associated with record of data on an optical disk and reproduction of data recorded on the optical disk, having: a first memory for storing a first software to perform a first processing; a second memory for storing a second software to perform a second processing; and processing means for reading the first and second software from the first memory and the second memory to independently perform the first processing and the second processing each other, the first processing includes a seek controlling process of performing a seek control of the optical disk, and the second processing includes a detection processing of detecting that data stored in a buffer memory temporarily storing data which the processing means reads from the optical disk is data storage location of last block of a first data area, notification processing of notifying a request for a seek for first block of a second data area following last block of the first data area to the first software, and connection processing of connecting the last block of the first data area and the first block of the second data area which are logically continuous.

According to the configuration, by providing the second processing with the detection processing, the calculation processing, the notification processing, and the connection processing, a part of the cross-DA process unique to the CD-MRW standards that is common to any optical disk apparatus can be allotted to the second software, which makes it possible to improve processing performance and to achieve high speed reproduction through the improvement of processing performance.

Furthermore, a speed of which the processing means reads the first software from the first memory is lower than a speed of which the processing means reads the second software from the second memory.

Furthermore, the first memory is flash memory, and the second memory is ROM.

Furthermore, the first program is firmware and the second program is a μ code.

Furthermore, the defect management information is in conformity with Mt. Rainier standards of optical disks.

The invention provides a method of controlling an optical disk apparatus for recording data on an optical disk and reproducing data recorded on the optical disk which incorporates an optical disk controller having a first memory for storing a first software to perform a first processing, a second memory for storing a second software to perform a second processing, and processing means for independently performing the first processing and the second processing each other, having the steps of: transmitting defect management information indicating alternative storage location of defective block of data recorded on the optical disk to a memory storing the second software by the first software; detecting that the a block of a storage location of data to be read is a defective block based on the defect management information, when the second software detects the storage location of data to be read in response to a data transfer request command, by the second software; requesting the first software of a seek for the alternative storage location by the second software based on the defect management information, when detecting that the storage location of the data to be read is a defective block, by the second software; performing a seek for the alternative storage location by the first software in response to the seek request; requesting the second software to store data reproduced from the optical disk in a buffer memory by the first software; and storing the reproduced data in the buffer memory by the second software.

According to the configuration, a customized part of the defect managing process unique to the CD-MRW standards can be allotted to the first software, and a part of the process common to any optical disk apparatus can be allotted to the second software, which makes it possible to improve processing performance and to achieve high speed reproduction through the improvement of processing performance.

The method of controlling an optical disk apparatus further has the steps of: judging that the alternative storage location of the data to be read is two or more consecutive blocks, when the block of the storage location of the data to be read is detected as the defective block, by the second software; and storing tow or more consecutive blocks of data read as a result of the seek for the first block of the alternative storage location in the buffer memory to accommodate the second and subsequent blocks of the alternative storage location if it is judged that the alternative storage location is two or more consecutive blocks.

According to the configuration, when it is detected that the storage location of data to be read is a defective block, processing performance can be improved by avoiding duplicate seek requests for two or more consecutive blocks of data stored in the alternative storage location.

The invention provides a method of controlling an optical disk apparatus for recording data on an optical disk and reproducing data recorded on the optical disk which incorporates an optical disk controller having a first memory for storing a first software to perform a first processing, a second memory for storing a second software to perform a second processing, and processing means for independently performing the first processing and the second processing each other, having the steps of: detecting that data stored in a buffer memory is a last address of a first data area, when the second software reads data recorded on the optical disk in response to a data transfer request command, by the second software; calculating a first address of the second data area next to the first data area, when the second software detects that the data stored in the buffer memory is the last address of the first data area, by the second software; requesting the first software of a seek for the first address of the second data area calculated by the second program; performing a seek for an alternative storage location by the first software in response to the seek request; requesting the second software to store data reproduced from the optical disk in the buffer memory by the first software; storing the reproduced data in the buffer memory by the second software; and connecting data in the last address of the first data area that has already been stored in the buffer memory and data in the first address of the second data area by the second program.

According to the configuration, a customized part of the cross-DA process unique to the CD-MRW standards can be allotted to the first software, and a part of the process common to any optical disk apparatus can be allotted to the second software, which makes it possible to improve processing performance and to achieve high speed reproduction through the improvement of processing performance.

### BRIEF DESCRIPTION OF THE DRAWINGS

FIG. 1 is a block diagram showing a configuration of an optical disk apparatus utilizing an optical disk controller according to a first embodiment of the invention;

FIG. 2 is a process flow chart showing an example of a defect managing process in the optical disk controller according to the first embodiment of the invention;

FIG. 3 is a block diagram showing a configuration of an optical disk apparatus utilizing an optical disk controller according to a second embodiment of the invention;

FIG. 4 is a process flow chart showing an example of a defect managing process in the optical disk controller according to the second embodiment of the invention;

FIG. 5 is a block diagram showing a configuration of an optical disk apparatus utilizing an optical disk controller according to a third embodiment of the invention;

FIG. 6 is a process flow chart showing an example of a defect managing process in the optical disk controller according to the third embodiment of the invention;

FIG. 7 is a process flow chart showing a defect managing process performed according to the first embodiment when an alternative storage location for a defective block is two or more consecutive blocks;

FIG. 8 is a block diagram showing a configuration of an optical disk apparatus utilizing an optical disk controller according to a fourth embodiment of the invention;

FIGS. 9A and 9B show an example of a table of defect management information obtained by extracting only information required for reproduction with the optical disk controller according to the fourth embodiment of the invention; and

FIG. 10 is a block diagram showing a configuration of an optical disk apparatus utilizing an optical disk controller according to the related art.

### DETAILED DESCRIPTION OF THE PREFERRED EMBODIMENTS

Preferred embodiments of the invention will now be described with reference to the drawings. In the following description, an optical disk apparatus is an apparatus that can reproduce plural types of optical disks having different physical structures and logical structures such as DVD-ROM, CD-ROM, and CD-R/RW.

(First Embodiment)

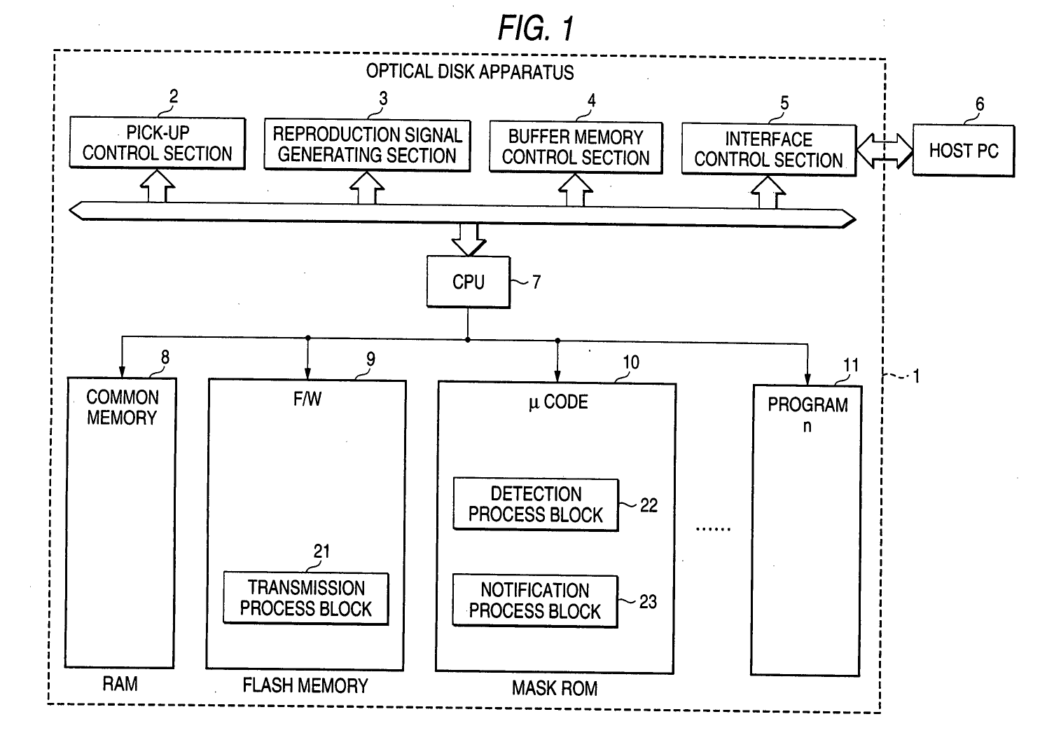

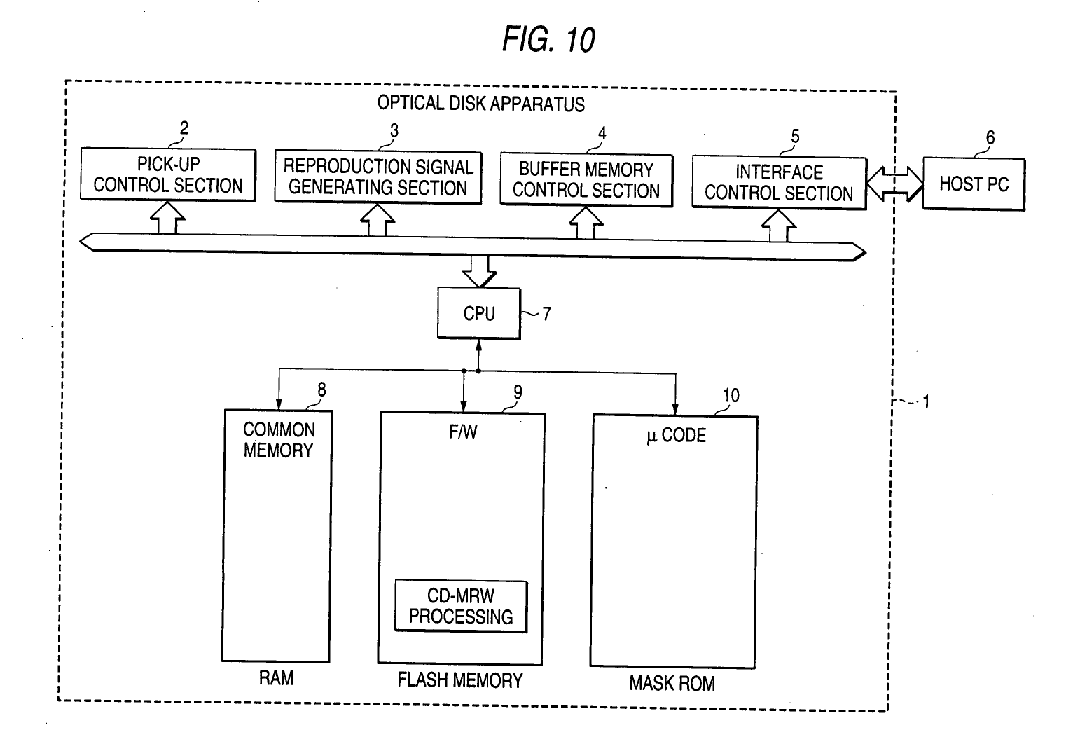

FIG. 1 is a block diagram showing a configuration of an optical disk apparatus utilizing an optical disk controller according to a first embodiment of the invention. Parts identical to parts shown in FIG. 10 will be described using like reference numerals. In FIG. 1, reference numeral 1 represents the optical disk apparatus; reference numeral 2 represents a pick-up control section; reference numeral 3 represents a reproduction signal generating section; reference numeral 4 represents a buffer memory control section; reference numeral 5 represents an interface control section; reference numeral 6 represents a host personal computer (host PC); reference numeral 7 represents a CPU of the optical disk controller; reference numeral 8 represents a RAM such as a DRAM; reference numeral 9 represents a flash memory; reference numeral 10 represents a mask ROM; and reference numeral 11 represents an n-th memory.

As a processing function included in the firmware that is provided in the flash memory 9, a transmission process block 21 for transmitting storage location information on data recorded on an optical disk to a μ code along with defect management information indicating an alternative storage location for a defective block is shown. As processing functions included in the μ code that is provided in the mask ROM 10, a detection process block 22 for detecting the storage location of data and a notification process block 23 for notifying the firmware of a seek request are shown.

The CPU 7 executes n programs having no mutual link independently of each other, the first program being the firmware stored in the flash memory 9 that is a first memory, the second program being the μ code stored in the mask ROM 10 that is a second memory, the n-th program being stored in the n-th memory 11. The n programs having no mutual link perform processing in cooperation with each other through the RAM 8 that has a small capacity.

The firmware is a program for controlling a system as a whole and is customized for each manufacture in order to achieve system specifications of their optical disk apparatus, in general. The customization of the firmware makes it possible to control optical disk apparatus having optical pick-ups and optical disk driving sections in different specifications in an optimum way in accordance with the respective specifications.

The μ code is a program that executes complicated signal processing associated with an optical disk using a signal processing circuit and allows the firmware to utilize results of the signal processing, and it allows a common process that is not dependent upon system specifications of optical disk apparatus.

The CPU 7 for controlling the entire system of the optical disk apparatus 1 causes the n programs including the firmware and the μ code to operate on a switched basis and makes a seek request to the pick-up control section 2 that controls a light spot when it receives a data transfer request command for reading data stored in an optical disk from the host PC 6 through the interface control section 5. Thereafter, it reproduces the data from an RF signal, accumulates it in a buffer memory, and transfers it to the host PC 6 through the interface control section 5, such normal and basic operations being the same as those described in the section of the related art.

Major processing functions of the first embodiment will now be described. When a data transfer request command is issued by the host PC 6, the μ code executes a series of processes, i.e., it analyzes the command that is received by the interface control section 5, judges whether there is data that has been read from the buffer memory control section 4, requests the firmware to read data if there is no read data in the buffer memory, transfers the data read into the buffer memory to the host PC 6, and then performs an interface command terminating protocol process.

The transmission process block 21 of the firmware transmits information on the storage location of the data recorded on the optical disk to the μ code in advance. Further, when the optical disk to be reproduced is a CD-R/RW type disk, the transmission to the μ code includes defect management information indicating an alternative storage location for a defective block in the data recorded on the optical disk.

When a data transfer request is made by the host PC 6, the detection process block 22 of the μ code detects the storage location of the data to be read based on information that is transmitted in advance by the transmission process block 21. At this time, when the optical disk to be reproduced is a CD-R/RW type disk and there is information that constitutes defect management information, the storage location of the read data to be detected will be an alternative storage location.

Further, when no data has been read into the buffer memory, the notification process block 23 of the μ code makes a seek request to the firmware based on the result of the detection by the detection process block 22. Upon receipt of the seek request, the firmware instructs the pick-up control section 2 to move the light spot to the location where the desired data is stored based on the current state of the optical spot and the location being scanned.

The pick-up control section 2 performs necessary processes to generate a traverse driving signal for moving the optical pick-up in the radial direction of the optical disk, thereby searching the desired location. After the search, data read from the desired location is input to the buffer memory through the reproduction signal generating section 3. The data input to the buffer memory is transferred to the host PC 6 through the interface control section 5 at predetermined timing.

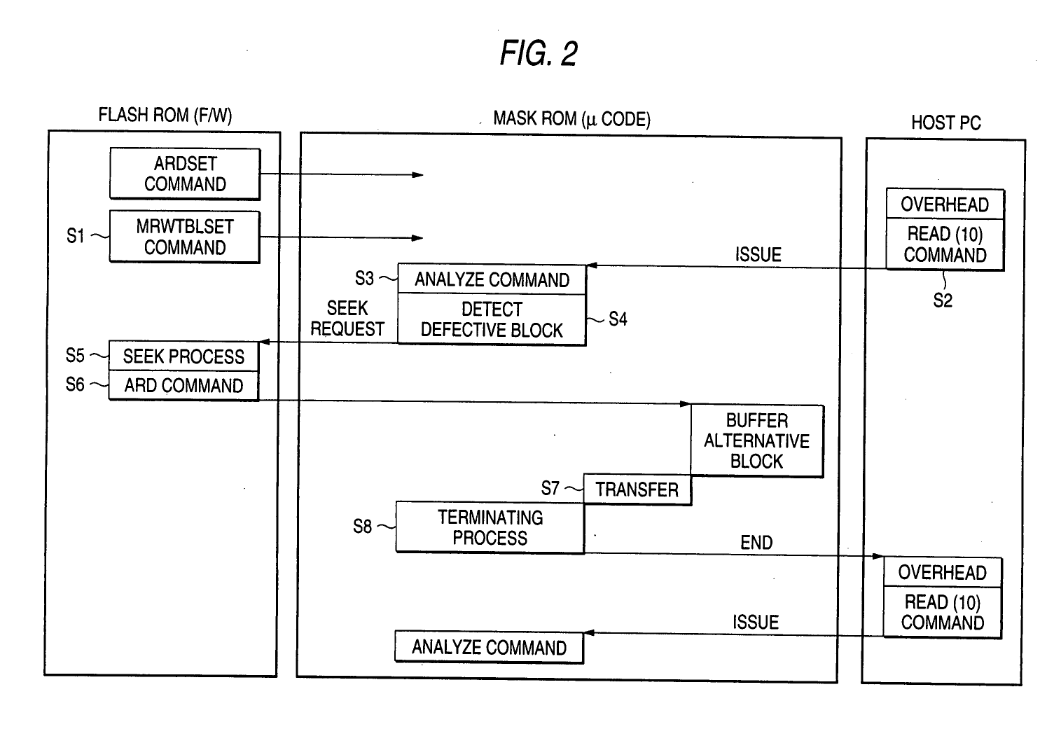

FIG. 2 is a flow chart showing a flow of the defect managing process unique to the CD-MRW standards to be performed in the optical disk apparatus 1 of the first embodiment when the optical disk to be reproduced is a CD-R/RW type disk. For example, it is assumed that the firmware is executed at a rate in the range from 2 to 8 MIPS and the μ code is executed at a rate of 33 MIPS.

First, the transmission process block 21 of the firmware transmits information on the storage location of data recorded on the optical disk to the μ code, and defect management information including an alternative storage location for the recorded data is transmitted in the form of an MRWTBLSET command to the μ code in advance at step S1. Next, when a READ command that is a data transfer request is issued by the host PC at step S2, the μ code analyzes the command thus received at step S3.

After the received command is analyzed, when the detection process block 22 of the μ code detects at step S4 that the storage location of the data to be read is a defective block based on the defect management information transmitted by the firmware as a result of the detection of the storage location of the data, the notification block 23 notifies the firmware of a request for a seek for the alternative storage location where the data to be read is actually stored.

Upon receipt of the seek request, the firmware performs a process of seeking the alternative storage location at step S5, reproduces the data with the reproduction signal generating section 3 at step S6, and issues an ARD command for requesting storing of the data in the buffer memory to the buffer memory control section 4.

Upon receipt of the ARD command, the μ code stores the data in the buffer memory, transfers the data stored in the buffer memory to the host PC with the interface control section 5 at step S7, and performs an interface command terminating protocol process at step S8.

In the first embodiment, the firmware is provided with the transmission process block, and the μ code is provided with the detection process block and the notification process block. A customized part of the detect managing process unique to the CD-MRW standards is subjected to be allotted to the firmware, and a part of the process common to any optical disk apparatus is subjected to be allotted to the μ code. This makes it possible to improve processing performance and to achieve high speed reproduction through the improvement in processing performance.

In the first embodiment, the information on the storage location of data recorded in an optical disk may be provided in the form of a table when it is transmitted in advance from the firmware to the μ code. For example, defect management information may be transmitted in the form of a table for the defect managing process unique to the CD-MRW standards. As a result, when the storage location of requested data is a defective block, the search for the defective block (defect search) can be easily performed.

(Second Embodiment)

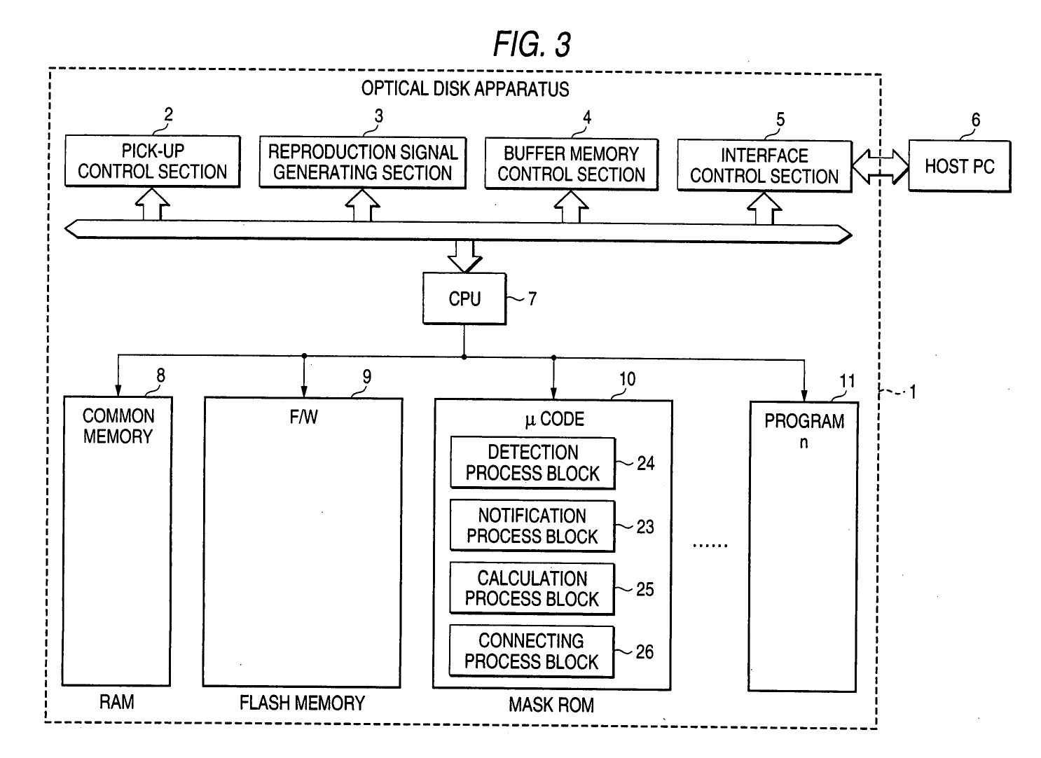

FIG. 3 is a block diagram showing a configuration of an optical disk apparatus utilizing an optical disk controller according to a second embodiment of the invention. In FIG. 3, parts identical to parts in FIG. 1 will be described using same reference numerals.

As processing functions included in a μ code stored in a mask ROM 10, a detection process block 24 for detecting the data storage location of the last block of an data area, a calculation process block 25 for calculating the data storage location of the first block of the data area that follows the last block of the data area, a notification process block 23 for notifying firmware of a seek request, and a connecting process block 26 for connecting the last block of the first data area and the first block of the next data area that are logically continuous are shown.

Major processing functions of the second embodiment will now be described. When a data transfer command is issued by a host PC 6, a μ code performs a series of operations, i.e., it analyzes the command that is received by an interface control section 5, judges whether there is any data that has been read from a buffer memory control section 4, requests firmware to read data when there is no read data in the buffer memory, transfers the data read into the buffer memory to the host PC 6, and performs an interface command terminating protocol process.

At this time, when the host PC 6 requests a transfer of data stored in the last block of a first data area and the first block of a second data area that are not physically continuous but are logically continuous, the detection process block 24 of the μ code detects the data storage location of the last block of the first data area.

After the detection, the data in the last block is stored in the buffer memory, and the calculation process block 25 of the μ code calculates the data storage location of the first block of the second data area when it is judged that the logically continuous data to be read stored in the first block of the second data area is not present in the buffer memory.

Based on the result of the calculation at the calculation process block 25, the notification process block 23 of the μ code makes a seek request to the firmware to move the light spot. Upon receipt of the seek request, the firmware instructs the pick-up control section 2 to move the light spot to the location where the desired data is stored based on the current state of the light spot and the location being scanned.

A pick-up control section 2 performs necessary processes to generate a traverse driving signal for moving the optical pick-up in the radial direction of the optical disk, thereby searching the desired location. After the search, the data read from the desired location is input to the buffer memory through the reproduction signal generating section 3.

At this time, the data in the last block of the first data area that has already been stored in the buffer memory is connected to the data in the first block of the second data area that has been input later, the connection being carried out by the connection process block 26 for connecting data stored in the last block of a first data area and the first block of the next data area that are not physically continuous but are logically continuous. The connected data is transferred to the host PC 6 at predetermined timing through the interface control section 5.

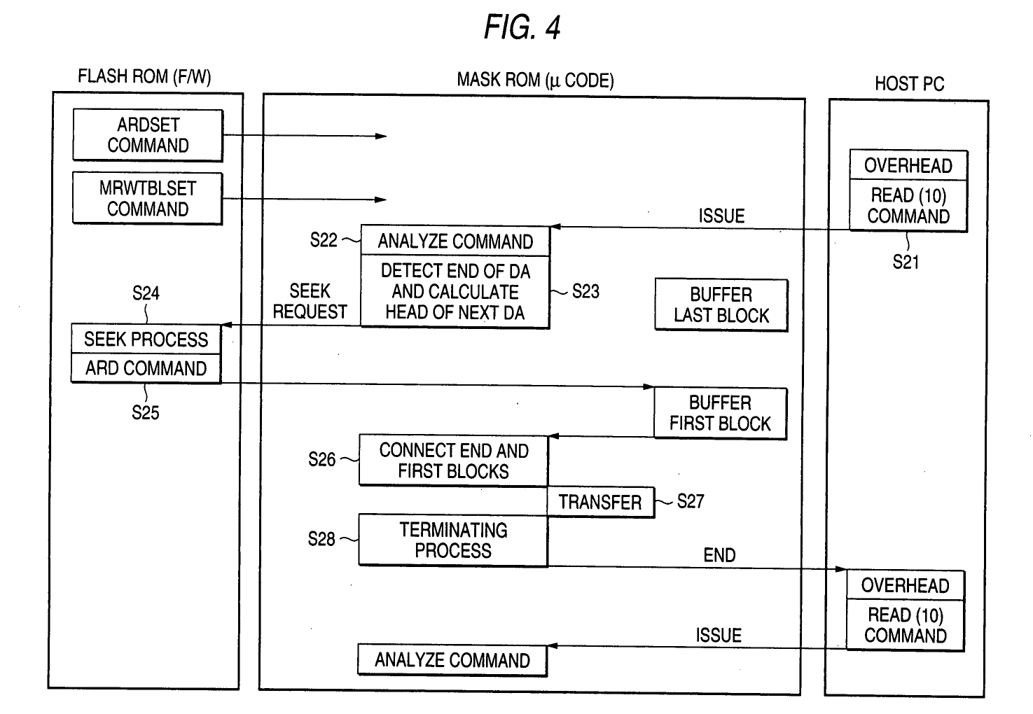

FIG. 4 is a flow chart showing a flow of the cross-DA process unique to the CD-MRW standards to be performed by the optical disk apparatus 1 according to the second embodiment when the optical disk to be reproduced is a CD-R/RW type disk. It is assumed that the firmware is executed at a rate in the range from 2 to 8 MIPS and the μ code is executed at a rate of 33 MIPS.

First, when the host PC issues a READ command that is a data transfer request requiring the cross-DA process at step S21, the μ code analyzes the received command at step S22.

When the detection process block 24 of the μ code detects the last address of a data area at step S23 after the command is analyzed, the data in the last address is stored in the buffer memory; the first address of the next data area is thereafter calculated by the calculation process block 25; and the notification process block 23 notifies the firmware of a request for a seek for the calculated address.

Upon receipt of the seek request, the firmware performs a process of seeking the first address of the next data area and reproduces the data with the reproduction signal generating section 3 at step S24 and issues an ARD command requesting the buffer memory control section 4 to store the data in the buffer memory at step S25.

Upon receipt of the ARD command, the μ code stores the data in the first address of the next data area in the buffer memory, and the connection process block 26 connects the data in the last address of the data that has already been stored in the buffer memory with the data in the first address of the next data area at step S26.

Further, the μ code transfers the connected data from the buffer memory to the host PC using the interface control section 5 at step S27 and performs an interface command terminating protocol process at step S28.

In the second embodiment, the μ code is provided with the detection process block, the calculation process block, the notification process block, and the connecting process block. A part of the cross-DA process unique to the CD-MRW standards that is common to any optical disk apparatus can be performed by the μ code to improve processing performance. The improvement in processing performance makes it possible to achieve high speed reproduction at the same time.

(Third Embodiment)

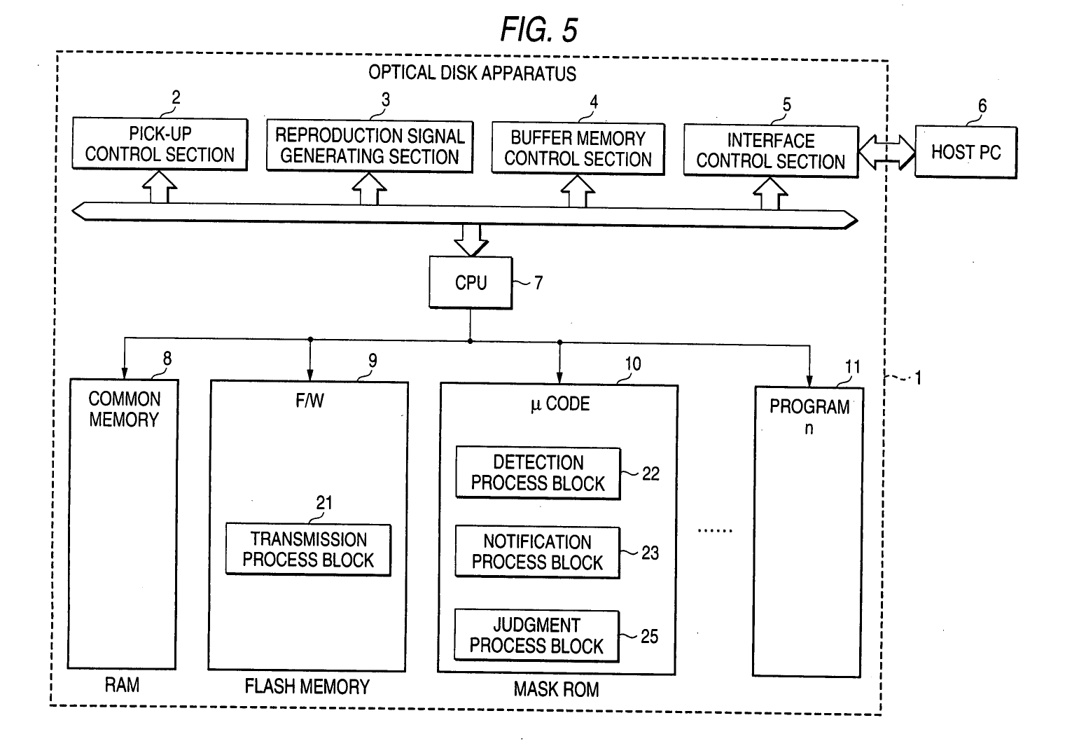

FIG. 5 is a block diagram showing a configuration of an optical disk apparatus utilizing an optical disk controller according to a third embodiment of the invention. In FIG. 5, parts identical to parts in FIG. 1 are described using same reference numerals.

As a processing function included in firmware that is provided in a flash memory 9, a transmission process block 21 for transmitting information on the storage location of data recorded on an optical disk to a μ code along with defect management information indicating an alternative storage location for a defective block is shown. As processing functions included in the μ code that is provided in a mask ROM 10, a detection process block 22 for detecting that the storage location of data is a defective block, a notification process block 23 for notifying the firmware of a seek request, and a judgment process block 27 for judging whether an alternative storage location is two or more consecutive blocks are shown.

Major processing functions in the third embodiment will now be described. When a data transfer request command is issued by a host PC 6, the μ code executes a series of processes, i.e., it analyzes the command that is received by the interface control section 5, judges whether there is data that has been read from the buffer memory control section 4, requests the firmware to read data if there is no read data in the buffer memory, transfers the data read into the buffer memory to the host PC 6, and then performs an interface command terminating protocol process.

The transmission process block 21 of the firmware transmits information on the storage location of the data recorded on the optical disk to the μ code in advance. Further, when the optical disk to be reproduced is a CD-R/RW type disk, the transmission to the μ code includes defect management information indicating an alternative storage location for a defective block in the data recorded on the optical disk.

When a data transfer request is made by the host PC 6, the detection process block 22 of the μ code detects the storage location of the data to be read based on information that is transmitted in advance by the transmission process block 21. At this time, when the optical disk to be reproduced is a CD-R/RW type disk and there is information that constitutes defect management information, the storage location of the read data to be detected will be an alternative storage location.

Further, when no data has been read into the buffer memory, the notification process block 23 of the μ code makes a seek request to the firmware based on the result of the detection by the detection process block 22. Upon receipt of the seek request, the firmware instructs a pick-up control section 2 to move the light spot to the location where the desired data is stored based on the current state of the light spot and the location being scanned.

The pick-up control section 2 performs necessary processes to generate a traverse driving signal for moving the optical pick-up in the radial direction of the optical disk, thereby searching the desired location. At this time, when the optical disk to be reproduced is a CD-R/RW type disk and there is information that corresponds to defect management information, the judgment process block 27 of the μ code judges whether the data to be read constitutes two or more consecutive blocks based on the alternative storage location information after the search.

Based on the judgment result of the judgment process block 27, the two or more consecutive blocks of data stored in the alternative storage location are continuously reproduced by a reproduction signal generating section 3 and input to their original data location of the buffer memory. The data input to the buffer memory is output to the host PC 6 through the interface control section 5 at predetermined timing.

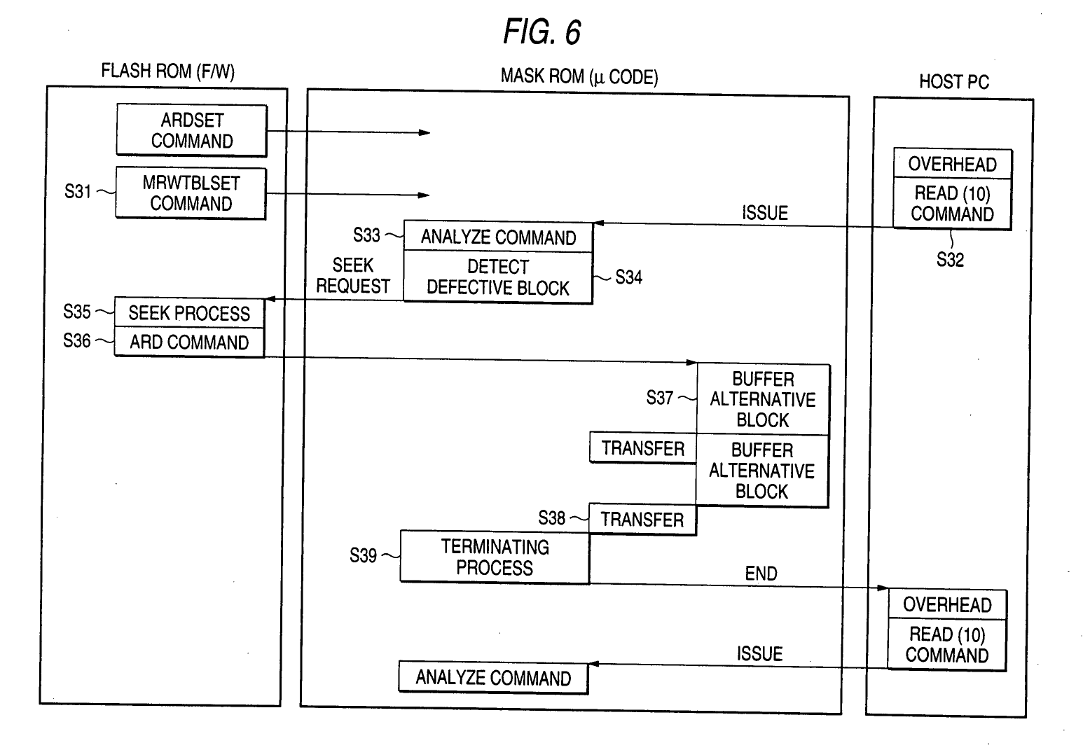

FIG. 6 is a flow chart showing a flow of the defect managing process unique to the CD-MRW standards to be performed in the optical disk apparatus 1 of the third embodiment when the optical disk to be reproduced is a CD-R/RW type disk. For example, it is assumed that the firmware is executed at a rate in the range from 2 to 8 MIPS and the μ code is executed at a rate of 33 MIPS.

First, the transmission process block 21 of the firmware transmits information on the storage location of data recorded on the optical disk to the μ code, and defect management information including an alternative storage location for the recorded data is transmitted in the form of an MRWTBLSET command to the μ code in advance at step S31. Next, when a READ command that is a data transfer request is issued by the host PC at step S32, the μ code analyzes the command thus received at step S33.

After the received command is analyzed, when the detection process block 22 of the μ code detects at step S34 that the storage location of the data to be read is a defective block based on the defect management information transmitted by the firmware as a result of the detection of the storage location of the data, the notification block 23 notifies the firmware of a request for a seek for the alternative storage location where the data to be read is actually stored.

Upon receipt of the seek request, the firmware performs a process of seeking the alternative storage location at step S35, reproduces the data with the reproduction signal generating section 3 at step S36, and issues an ARD command for requesting storing of the data in the buffer memory to the buffer memory control section 4. Upon receipt of the ARM command, the μ code stores the data in the buffer memory.

At this time, the judgment process block 27 judges at step S37 whether the alternative storage location where the data to be read is stored is two or more consecutive blocks based on the defect management information transmitted to the μ code from the transmission process block 21 in advance. When it is judged that the alternative storage location constitutes two consecutive blocks, the two consecutive blocks of reproduced data are stored in the buffer memory without notifying the firmware of a seek request.

Further, the data stored in the buffer memory is transferred to the host PC by the interface control section 5 at step S38, and an interface command terminating protocol process is performed at step S39.

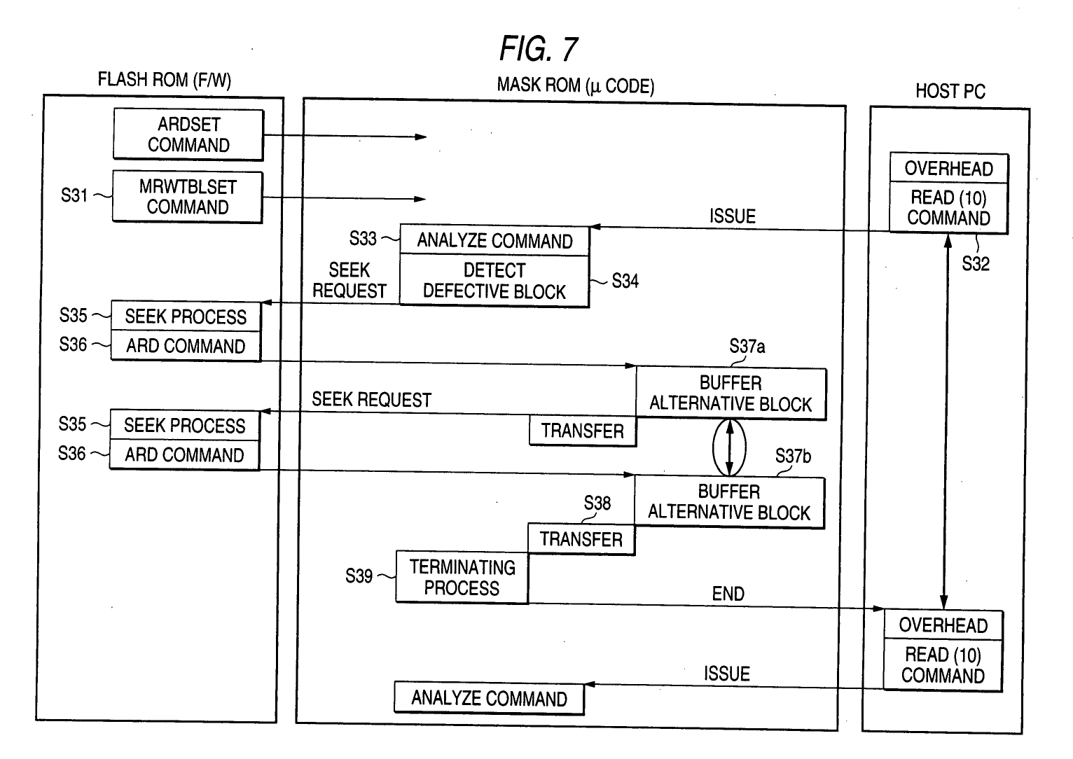

FIG. 7 is a flow chart showing a flow of a defect managing process performed according to the third embodiment for the purpose of comparing the third embodiment with the first embodiment. In the flow chart shown in FIG. 7, since there is no function of judging whether an alternative storage location where data to be read is stored is two consecutive blocks, the notification process block 23 notifies the firmware of a request for a seek for the next consecutive alternative blocks at step S37a.

In the third embodiment, a judgment process block is provided in addition to the first embodiment, which makes it possible not only to achieve the defect managing process unique to the CD-MRW standards and high speed reproduction of a CD at the same time but also to achieve improved processing performance by avoiding duplicate requests for a seek for data that is stored in two or more consecutive blocks in an alternate storage location.

(Fourth Embodiment)

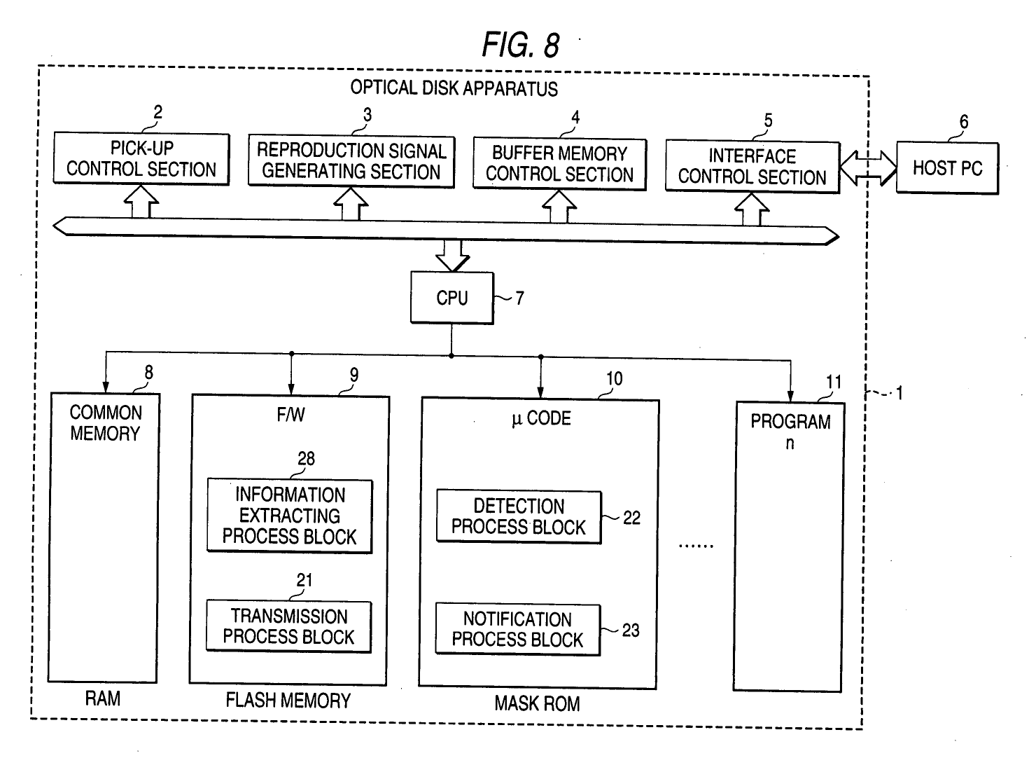

FIG. 8 is a block diagram showing a configuration of an optical disk apparatus utilizing an optical disk controller according to a fourth embodiment of the invention. In FIG. 8, parts identical to parts shown in FIG. 1 are described using same reference numerals.

As a processing function included in firmware that is provided in a flash memory 9, a transmission process block 21 for transmitting information on the storage location of data recorded on optical disk to a μ code along with defect management information indicating an alternative storage location for a defective block and an information extracting process block 28 for extracting only information required for reproduction from the storage location information for the data recorded on the optical disk including the defect management information are shown. As a processing function included in the μ code that is provided in a mask ROM 10, a detection process block 22 for detecting that the storage location of data is a defective block and a notification process block 23 for notifying the firmware of a seek request is shown.

A description will now be made on the information extracting process block 28 that is a major function of the fourth embodiment. The transmission process block 21 of the firmware transmits information on the storage location of the data recorded on the optical disk to the μ code in advance. Further, when the optical disk to be reproduced is a CD-R/RW type disk, the transmission to the μ code includes defect management information indicating an alternative storage location for the data recorded on the optical disk.

The information extracting process block 28 extracts only information required for reproduction from the storage location information of the data recorded on the optical disk, and the extracted information is transmitted to the μ code by the transmission process block 21.

A detailed description will now be made on the defect managing process unique to the CD-MRW standards to be performed in the optical disk apparatus 1 of the fourth embodiment when the optical disk to be reproduced is a CD-R/RW type disk. For example, it is assumed that the firmware is executed at a rate in the range from 2 to 8 MIPS and the μ code is executed at a rate of 33 MIPS.

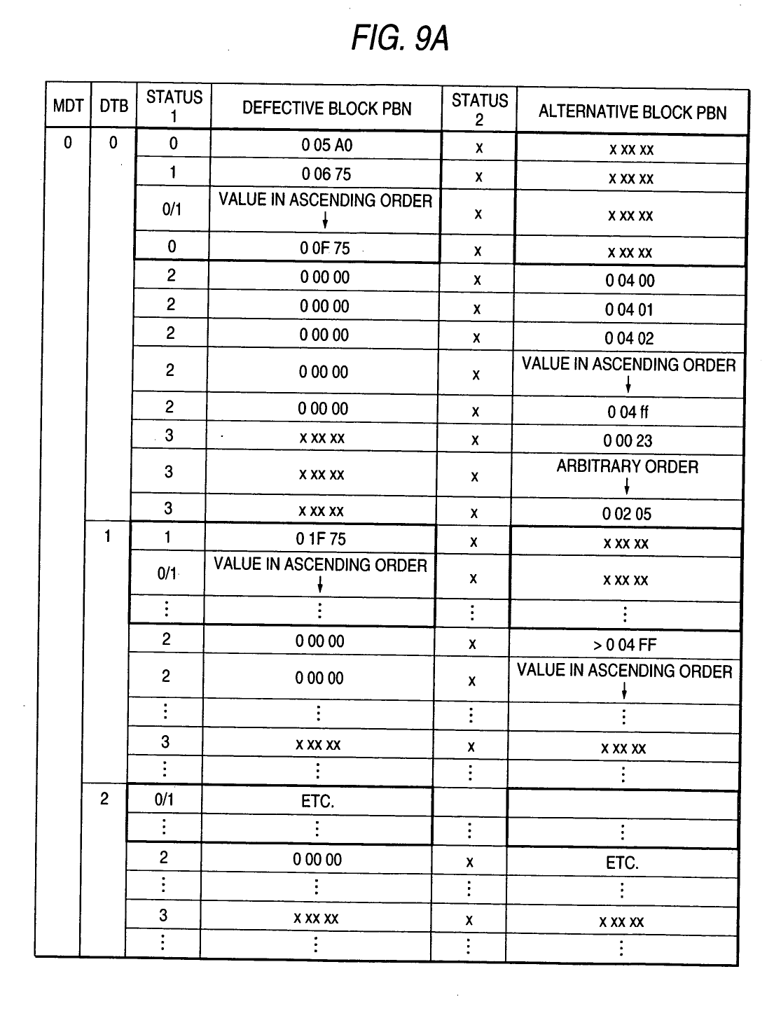

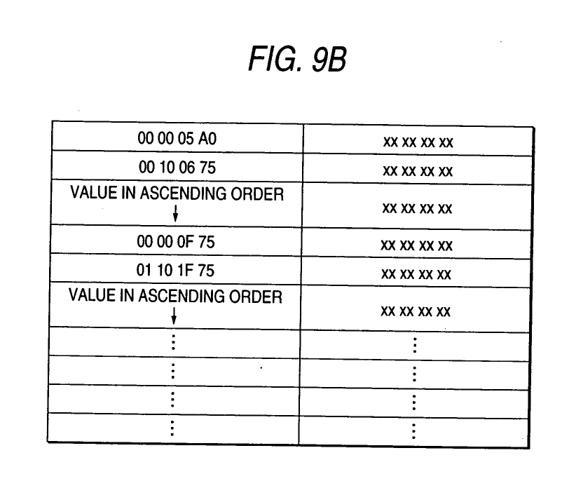

FIGS. 9A and 9B show a specific example of the extraction of only information required for reproduction from defect management information required for the defect managing process unique to the CD-MRW standards. For better understanding of the description, it is assumed that addresses of defective blocks that constitute the defect management information have already been arranged into a table in an ascending order in the fourth embodiment.

Only information required for reproduction of a CD-R/RW is extracted by the information extracting process block 28 from the table of defect management information generated by the firmware shown in FIG. 9A, and information on the table of the extracted defect management information shown in FIG. 9B is transmitted in the form of an MRWTBLSET command by the transmission process block 21 from the firmware to the μ code.

According to the fourth embodiment, the information extracting process block is provided in addition to the first embodiment to simplify the setting of a table of defect management information, which makes it possible not only to perform the defect managing process unique to the CD-MRW standards and to achieve high speed reproduction of a CD at the same time but also to reduce the burden born by the μ code in searching defects.

As described above, the above embodiments allow a process unique to the CD-MRW standards to be separated into a part that is customized and a part that is common to any optical disk apparatus, thereby improving processing performance. Further, the improvement in processing performance allows reproduction at a higher speed.

1. An optical disk controller, which performs a control associated with record of data on an optical disk and reproduction of data recorded on the optical disk, comprising:
a first memory for storing a first software to perform a first processing;
a second memory for storing a second software to perform a second processing; and
processing means for reading the first and second software from the first memory and the second memory to independently perform the first processing and the second processing each other,
the first processing includes a seek control processing of performing a seek control of the optical disk, and a transmission processing of transmitting information indicating the storage location of data recorded on the optical disk, which includes defect management information indicating an alternative storage location of a defective block, to the second software, and
the second processing includes a detection processing of detecting the storage location of data recorded on the optical disk based on the storage location information, and a notification processing of notifying a request for seeking the storage location, in which data detected by the detection process is recorded on the optical disk, to the first software.

2. The optical disk controller according to claim 1, further comprising:
a plurality of the first software; and
a plurality of the first memory.

3. The optical disk controller according to claim 1, wherein a speed of which the processing means reads the first software from the first memory is lower than a speed of which the processing means reads the second software from the second memory.

4. The optical disk controller according to claim 1, wherein the first memory is flash memory, and the second memory is ROM.

5. The optical disk controller according to claim 1, wherein the first program is firmware and the second program is a μ code.

6. The optical disk controller according to claim 1, wherein the second processing includes a defect detection processing of detecting that a block of the storage location detected by the detection processing is a defective block, and judgment processing of judging whether an alternative storage location of data to be read is two or more consecutive blocks based on the defect management information when the block of the storage location of detected by the detection processing is the defective block,
wherein two or more consecutive blocks of data read as a result of a seek for a first block of the alternative storage location are stored in a buffer memory to accommodate a second and subsequent blocks of the alternative storage location when the judgment processing judges that the alternative storage location of the data to be read is two or more consecutive blocks.

7. The optical disk controller according to claim 1, wherein the first processing has information extraction processing of extracting only information required for reproduction of the data stored on the optical disk and organizing the information into a defect management information to be transmitted to the second software.

8. The optical disk controller according to claim 1, wherein the defect management information is organized in tabular form.

9. The optical disk controller according to claim 7, wherein data storage locations of the defect management information are arranged in an ascending order.

10. The optical disk controller according to claim 7, wherein the defect management information includes an identification code which indicates an end of a table.

11. The optical disk controller according to claim 1, wherein the defect management information is in conformity with Mt. Rainier standards of optical disks.

12. An optical disk controller, which performs a control associated with record of data on an optical disk and reproduction of data recorded on the optical disk, comprising:
a first memory for storing a first software to perform a first processing;
a second memory for storing a second software to perform a second processing; and
processing means for reading the first and second software from the first memory and the second memory to independently perform the first processing and the second processing each other,
the first processing includes a seek controlling process of performing a seek control of the optical disk, and
the second processing includes a detection processing of detecting that data stored in a buffer memory temporarily storing data which the processing means reads from the optical disk is data storage location of last block of a first data area, notification processing of notifying a request for a seek for first block of a second data area following last block of the first data area to the first software, and connection processing of connecting the last block of the first data area and the first block of the second data area which are logically continuous.

13. The optical disk controller according to claim 12, wherein a speed of which the processing means reads the first software from the first memory is lower than a speed of which the processing means reads the second software from the second memory.

14. The optical disk controller according to claim 12, wherein the first memory is flash memory, and the second memory is ROM.

15. The optical disk controller according to claim 12, wherein the first program is firmware and the second program is a μ code.

16. The optical disk controller according to claim 12, wherein the defect management information is in conformity with Mt. Rainier standards of optical disks.

17. A method of controlling an optical disk apparatus for recording data on an optical disk and reproducing data recorded on the optical disk which incorporates an optical disk controller having a first memory for storing a first software to perform a first processing, a second memory for storing a second software to perform a second processing, and processing means for independently performing the first processing and the second processing each other, comprising the steps of:
transmitting defect management information indicating alternative storage location of defective block of data recorded on the optical disk to a memory storing the second software by the first software;
detecting that the a block of a storage location of data to be read is a defective block based on the defect management information, when the second software detects the storage location of data to be read in response to a data transfer request command, by the second software;
requesting the first software of a seek for the alternative storage location by the second software based on the defect management information, when detecting that the storage location of the data to be read is a defective block, by the second software;
performing a seek for the alternative storage location by the first software in response to the seek request;
requesting the second software to store data reproduced from the optical disk in a buffer memory by the first software; and
storing the reproduced data in the buffer memory by the second software.

18. The method of controlling an optical disk apparatus according to claim 17, further comprising the step of:
judging that the alternative storage location of the data to be read is two or more consecutive blocks, when the block of the storage location of the data to be read is detected as the defective block, by the second software; and
storing tow or more consecutive blocks of data read as a result of the seek for the first block of the alternative storage location in the buffer memory to accommodate the second and subsequent blocks of the alternative storage location if it is judged that the alternative storage location is two or more consecutive blocks.

19. A method of controlling an optical disk apparatus for recording data on an optical disk and reproducing data recorded on the optical disk which incorporates an optical disk controller having a first memory for storing a first software to perform a first processing, a second memory for storing a second software to perform a second processing, and processing means for independently performing the first processing and the second processing each other, comprising the steps of:
detecting that data stored in a buffer memory is a last address of a first data area, when the second software reads data recorded on the optical disk in response to a data transfer request command, by the second software;
calculating a first address of the second data area next to the first data area, when the second software detects that the data stored in the buffer memory is the last address of the first data area, by the second software;
requesting the first software of a seek for the first address of the second data area calculated by the second program;
performing a seek for an alternative storage location by the first software in response to the seek request;
requesting the second software to store data reproduced from the optical disk in the buffer memory by the first software;
storing the reproduced data in the buffer memory by the second software; and
connecting data in the last address of the first data area that has already been stored in the buffer memory and data in the first address of the second data area by the second program.

20. An optical disk apparatus comprising an optical disk controller according to claim 1.

21. An optical disk apparatus comprising an optical disk controller according to claim 11.
